(19) United States
(12) Patent Application Publication
(10) Pub. No.: US 2012/0007811 A1
(43) Pub. Date: Jan. 12, 2012

(54) ELECTRONIC DEVICE, MULTI-MODE INPUT/OUTPUT DEVICE AND MODE-SWITCHING METHOD THEREOF

(75) Inventor: Szu-Jung Peng, Taipei City (TW)

(73) Assignee: COMPAL ELECTRONICS, INC., Taipei City (TW)

(21) Appl. No.: 12/880,176

(22) Filed: Sep. 13, 2010

(30) Foreign Application Priority Data
Jul. 7, 2010 (TW) 99122358

(51) Int. Cl. G06F 3/041

(52) U.S. Cl. 345/173

(57) ABSTRACT

An electronic device, a multi-mode input/output device, and a mode-switching method of the multi-mode input/output device are provided. The multi-mode input/output device includes a touch pad, electronic paper, and a switching module. An opening of the electronic device exposes a first surface of the electronic paper. A second surface of the electronic paper contacts to a touch-sensing plane of the touch pad. The second surface is opposite to the first surface. The switching module connects the touch pad and the electronic paper. When a mode-switching signal is received, the switching module switches the multi-mode input/output device between a first mode and a second mode. The multi-mode input/output device can switch between the two modes to perform different functions and have advantages of low power consumption and low costs.

### CROSS-REFERENCE TO RELATED APPLICATION

This application claims the priority benefit of Taiwan application serial no. 99122358, filed on Jul. 7, 2010. The entirety of the above-mentioned patent application is hereby incorporated by reference herein and made a part of this specification.

### BACKGROUND OF THE INVENTION

1. Field of the Invention

The invention relates to an input/output (I/O) device. More particularly, the invention relates to a multi-mode I/O device, an electronic device employing the multi-mode I/O device, and a mode-switching method of the multi-mode I/O device.

2. Description of Related Art

Notwithstanding rapid development of the networking technology and existence of computer accessible recording media including CD-ROM and portable hard drive, writing on paper is convenient and is apt to present superior printing effect, and therefore paper is still the mainstream medium for disseminating information. Nonetheless, a great number of trees are cut down in production of books, newspaper, magazines, commercial documents, or academic paper which all require mass consumption of paper. Owing to the rise of “environmental protection” awareness and continuous advancement of technologies, electronic paper featuring multi-page display and rewritablility gradually draws attention. Manufacturers of electronic paper all attempt to raise popularity of the electronic paper, so as to reduce use of conventional paper, economize the use of resources, and protect the environment.

In terms of technologies, a color conductive polymer material having a granular shape is sandwiched between two transparent films to form the electronic paper. Particles in the electronic paper used to be black and white particles respectively carrying positive and negative static charges. Due to the electromagnetic law of repulsion and attraction, when both positive and negative voltages are applied to the electronic paper, the statically-charged particles can be moved and arranged to form letters or patterns. Together with advancement of technologies, the black and white electronic paper little by little evolves into color electronic paper for displaying color frames on the electronic paper, thus improving display performance. In the future, the electronic paper characterized by compactness, low power consumption, and reduced color distortion is very much likely to be the main medium for information dissemination.

### SUMMARY OF THE INVENTION

The invention is directed to a multi-mode I/O device with a structure supporting a mode-switching action, so as to reduce power consumption.

The invention is also directed to an electronic device having a multi-mode I/O device which can switch to different operational modes with low costs.

The invention is also directed to a mode-switching method by applying which a multi-mode I/O device can switch to different operational modes, such that a user can execute a variety of operations.

In the invention, a multi-mode I/O device including a touch pad, electronic paper, and a switching module is provided. The touch pad has a touch-sensing plane. The electronic paper has a first surface and a second surface opposite to the first surface. An opening of an electronic device exposes the first surface of the electronic paper, and the second surface of the electronic paper contacts to the touch-sensing plane of the touch pad. The switching module connects the touch pad and the electronic paper. When a mode-switching signal is received, the switching module switches the multi-mode I/O device between a first mode and a second mode. If the multi-mode I/O device is switched to the first mode, a display function of the electronic paper is disabled, and the electronic device executes an operation based on a touch action sensed by the touch-sensing plane. If the multi-mode I/O device is switched to the second mode, an electronic book menu is displayed on the electronic paper, and a frame of the electronic book is displayed on the electronic paper based on the touch action sensed by the touch-sensing plane.

According to an embodiment of the invention, the mode-switching signal is triggered by the touch action sensed by a specific region on the touch-sensing plane.

According to an embodiment of the invention, the mode-switching signal is triggered when the touch action is constantly sensed by the touch-sensing plane for more than a predetermined period of time.

According to an embodiment of the invention, the mode-switching signal is triggered by a physical key of the electronic device.

According to an embodiment of the invention, when the electronic device executes the operation based on the touch action sensed by the touch-sensing plane, an operation frame corresponding to the operation is displayed on a main screen of the electronic device.

According to an embodiment of the invention, the frame of the electronic book includes at least one of the following: contents of the electronic book downloaded by the electronic device, an electronic book catalog, and a management interface of the electronic book.

According to an embodiment of the invention, the multi-mode I/O device further includes an adhesive layer disposed between the touch-sensing plane and the second surface.

According to an embodiment of the invention, the touch pad is a resistive touch pad.

From another perspective, in the invention, an electronic device including a main screen and a host hinged to the main screen is provided. The host includes a housing and a multi-mode I/O device. The housing has an opening, and the multi-mode I/O device is disposed in the housing. The multi-mode I/O device includes a touch pad, electronic paper, and a switching module. The touch pad has a touch-sensing plane. The electronic paper has a first surface and a second surface opposite to the first surface. The opening of the housing exposes the first surface of the electronic paper, and the second surface of the electronic paper contacts to the touch-sensing plane of the touch pad. The switching module connects the touch pad and the electronic paper. When a mode-switching signal is received, the switching module switches the multi-mode I/O device between a first mode and a second mode. If the multi-mode I/O device is switched to the first mode, a display function of the electronic paper is disabled, and the electronic device executes an operation based on a touch action sensed by the touch-sensing plane. If the multi-mode I/O device is switched to the second mode, an electronic book menu is displayed on the electronic paper, and a frame of the electronic book is displayed on the electronic paper based on the touch action sensed by the touch-sensing plane.

According to an embodiment of the invention, the mode-switching signal is triggered by the touch action sensed by a specific region on the touch-sensing plane.

According to an embodiment of the invention, the mode-switching signal is triggered when the touch action is constantly sensed by the touch-sensing plane for more than a predetermined period of time.

According to an embodiment of the invention, the mode-switching signal is triggered by a physical key of the electronic device.

According to an embodiment of the invention, when the electronic device executes the operation based on the touch action sensed by the touch-sensing plane, an operation frame corresponding to the operation is displayed on the main screen of the electronic device.

According to an embodiment of the invention, the frame of the electronic book includes at least one of the following: contents of the electronic book downloaded by the electronic device, an electronic book catalog, and a management interface of the electronic book.

According to an embodiment of the invention, the multi-mode I/O device further includes an adhesive layer disposed between the touch-sensing plane and the second surface.

According to an embodiment of the invention, the touch pad of the multi-mode I/O device is a resistive touch pad.

From still another perspective, in the invention, a mode-switching method including the step of providing a multi-mode I/O device is provided. The multi-mode I/O device includes a touch pad, electronic paper, and a switching module connecting the touch pad and the electronic paper. The touch pad has a touch-sensing plane. The electronic paper has a first surface and a second surface opposite to the first surface. An opening of an electronic device exposes the first surface of the electronic paper, and the second surface of the electronic paper contacts to the touch-sensing plane of the touch pad. When a mode-switching signal is received, the multi-mode I/O device is switched between a first mode and a second mode by the switching module. If the multi-mode I/O device is switched to the first mode, a display function of the electronic paper is disabled, and an operation is executed by the electronic device based on a touch action sensed by the touch-sensing plane. If the multi-mode I/O device is switched to the second mode, an electronic book menu is displayed on the electronic paper, and a frame of the electronic book is displayed on the electronic paper based on the touch action sensed by the touch-sensing plane.

According to an embodiment of the invention, the mode-switching method further includes one of the following steps: triggering the mode-switching signal by the touch action sensed by a specific region on the touch-sensing plane, triggering the mode-switching signal when the touch action is constantly sensed by the touch-sensing plane for more than a predetermined period of time, and triggering the mode-switching signal by a physical key of the electronic device.

According to an embodiment of the invention, when the electronic device executes the operation based on the touch action sensed by the touch-sensing plane, an operation frame corresponding to the operation is displayed on a main screen of the electronic device.

According to an embodiment of the invention, the frame of the electronic book includes at least one of the following: contents of the electronic book downloaded by the electronic device, an electronic book catalog, and a management interface of the electronic book.

In view of the above, the electronic paper is disposed on the touch pad according to the invention, and the electronic paper and the touch pad are integrated to form the multi-mode I/O device. The multi-mode I/O device is equipped with a touch-sensing function and a function of the electronic book. Based on users' demands, different functions can be provided by switching to different modes. Integration of the electronic paper and the touch pad leads to properties of low power consumption and low costs of the multi-mode I/O device.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating an electronic device according to an embodiment of the invention.

FIG. 2 is a block diagram illustrating a multi-mode I/O device according to an embodiment of the invention.

FIG. 3 is a side view illustrating a host of an electronic device according to an embodiment of the invention.

FIG. 4 is a side view illustrating appearance of a multi-mode I/O device according to an embodiment of the invention.

FIG. 5 is a flowchart illustrating a mode-switching method according to an embodiment of the invention.

### DESCRIPTION OF EMBODIMENTS

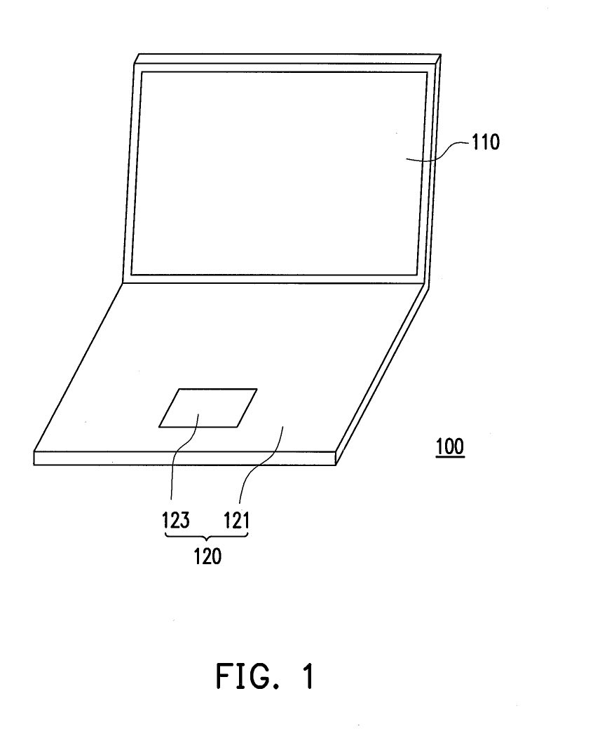

FIG. 1 is a schematic view illustrating an electronic device according to an embodiment of the invention. With reference to FIG. 1, an electronic device 100 includes a main screen 110 and a host 120 that is hinged to the main screen 110. The electronic device 100 is, for example, a notebook computer in this embodiment, which should not be construed as a limitation to this invention.

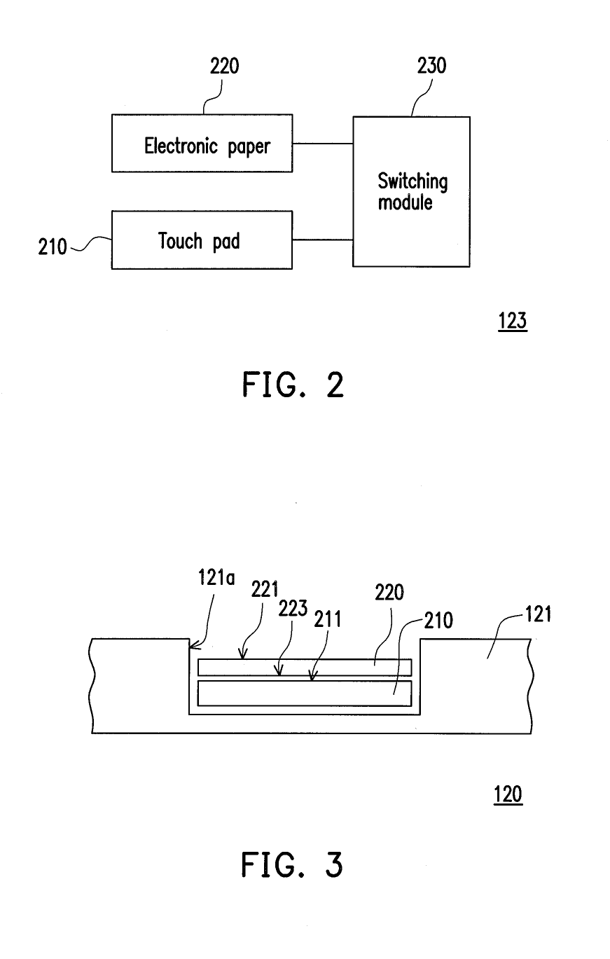

The host 120 includes a housing 121 and a multi-mode I/O device 123. FIG. 2 is a block diagram illustrating a multi-mode I/O device 123 according to an embodiment of the invention. As shown in FIG. 2, the multi-mode I/O device 123 includes a touch pad 210, electronic paper 220, and a switching module 230 connecting the touch pad 210 and the electronic paper 220. The touch pad 210, for example, is a pressure sensing element (e.g. a resistive touch pad) capable of sensing a touch action initiated by a user. The electronic paper 220 includes a plurality of conductive polymer materials of the spherical shape, and the conductive polymer materials can achieve a display function. The switching module 230 is, for example, a hardware component with the processing capability, a software component with the processing capability, or a combination thereof. Besides, the switching module 230 is used to switch the multi-mode I/O device 123 between different modes supported by the multi-mode I/O device 123 in accordance with the reception of a mode-switching signal. Detailed operation of the switching module 230 is elaborated hereinafter with the accompanying drawings.

FIG. 3 is a side view illustrating a host of an electronic device according to an embodiment of the invention. The appearance of the multi-mode I/O device 123 and the arrangement of the multi-mode I/O device 123 in the electronic device 100 are described below, as shown in FIG. 3. In FIG. 3, the housing 121 of the host 120 in the electronic device 100 has an opening 121a. The touch pad 210 has a touch-sensing plane 211. The electronic paper 220 has a first surface 221 and a second surface 223 opposite to the first surface 221.

The opening 121a of the electronic device 100 exposes the first surface 221 of the electronic paper 220, and the second surface 223 of the electronic paper 220 contacts to the touch-sensing plane 211 of the touch pad 210. When a user touches the multi-mode I/O device 123, the user touches the first surface 221 of the electronic paper 220. Since the electronic paper 220 is excessively thin, the touch pad 210 located below the electronic paper 220 can also sense and receive the touch action of the user.

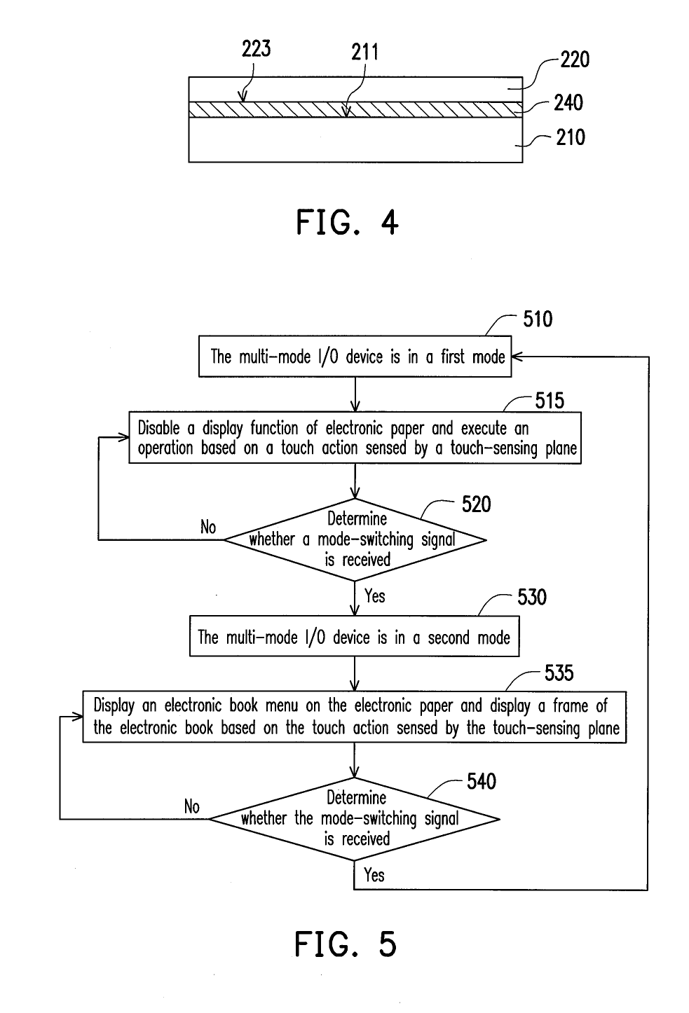

According to another embodiment, the multi-mode I/O module 123 further includes an adhesive layer (e.g. the adhesive layer 240 depicted in FIG. 4). The adhesive layer 240 is disposed between touch-sensing plane 211 of the touch pad 210 and the second surface 223 of the electronic paper 220, such that the touch pad 210 and the electronic paper 220 are adhered to each other. The adhesive layer 240, for example, is a back coat. This invention does not pose limitation to the material of the adhesive layer 240.

FIG. 5 is a flowchart illustrating a mode-switching method according to an embodiment of the invention. In this embodiment, it is assumed that the multi-mode I/O device 123 is initially in a first mode. As shown in step 510, after the electronic device 100 is powered on, the multi-mode I/O device 123 enters the first mode.

If the multi-mode I/O device 123 is in the first mode, as shown in step 515, a display function of the electronic paper 200 is disabled, such that no frame is displayed. Besides, when the user touches the multi-mode I/O device 123, the touch pad 210 generates a signal (which may include touch-sensing coordinate information) based on the touch action sensed by the touch-sensing plane 211, an embedded controller (not shown) of the electronic device 100 determines an instruction corresponding to the signal in accordance with an established standard, and an operation is correspondingly executed by the electronic device 100 based on the instruction.

Note that when the electronic device 100 executes the corresponding operation based on the touch action sensed by the touch-sensing plane 211, an operation frame corresponding to the operation is displayed on the main screen 110 of the electronic device 100. That is to say, the multi-mode I/O device 123 in the first mode is deemed as a touch-sensing device. A user can instruct the electronic device 100 to execute various operations by touching the multi-mode I/O device 123 and moving his or her fingers. Based on the design and the specifications of the touch pad 210, the multi-mode I/O device 123 can sense a single-touch action or a multiple-touch action, which is not limited in the invention.

Next, as shown in step 520, the switching module 230 determines whether a mode-switching signal is received or not. For instance, the mode-switching signal is triggered by a physical key of the electronic device 100. In another embodiment, the mode-switching signal is triggered when the touch action sensed by the touch-sensing plane 211 satisfies certain requirements. For instance, the mode-switching signal can be triggered when a user touches a specific region on the touch-sensing plane 211. In an alternative, the mode-switching signal can be triggered when the touch action is constantly sensed by the touch-sensing plane 211 for more than a predetermined period of time.

Before the switching module 230 receives the mode-switching signal, the multi-mode I/O device 123 is in the first mode. In addition, as indicated in step 515, the display function of the electronic paper 220 remains disabled, and an operation is executed by the electronic device 100 when a touch action is sensed by the touch-sensing plane 211. Nevertheless, if the switching module 230 determines the receipt of the mode-switching signal, the switching module 230 switches the multi-mode I/O device 123 currently in the first mode to the second mode, as shown in step 530.

As shown in step 535, once the multi-mode I/O device 123 enters the second mode, an electronic book menu is displayed on the electronic paper 220. The menu may include one or more menu items, such as an electronic book catalog menu item, a reading menu item, a management menu item (e.g. a setting menu item or a downloading menu item), and so forth. A frame of an electronic book is correspondingly displayed on the electronic paper 220 based on the touch action sensed by the touch-sensing plane 211. For instance, after the electronic book menu is displayed, given that a user touches the touch-sensing plane 211 of the touch pad 210 to select the downloading menu item, the electronic device 100 is controlled to connect to the internet, download the contents of a certain electronic book, and store the downloaded contents into a storage device (e.g. a hard drive) based on the touch action sensed by the touch-sensing plane 211, so as to establish an electronic book database. When the user selects the reading menu item by touching the touch-sensing plane 211, the touch action of the user is transformed into a corresponding instruction allowing the electronic paper 220 to display the electronic book catalog. After a specific electronic book is selected through the electronic book catalog, the touch pad 210 connects the electronic book database in the electronic device 100 to access the contents of the electronic book and display the contents on the electronic paper 220. On the other hand, when a user selects the management menu item by touching the touch-sensing plane 211, the touch action of the user is also transformed into a corresponding instruction allowing the electronic paper 220 to display the management interface for further setting.

As shown in step 540, the switching module 230 determines whether the mode-switching signal is received or not. If the switching module 230 does not receive the mode-switching signal, the multi-mode I/O device 123 is still in the second mode. In addition, as indicated in step 535, the electronic book menu is displayed on the electronic paper 220, and a frame of the electronic book is displayed on the electronic paper 220 based on the touch action sensed by the touch-sensing plane 211. Nevertheless, if the switching module 230 determines the receipt of the mode-switching signal, the switching module 230 switches the multi-mode I/O device 123 currently in the second mode back to the first mode, as shown in step 510.

As indicated in FIG. 5, as long as the switching module 230 receives the mode-switching signal, the switching module 230 controls the multi-mode I/O device 123 to switch from the current mode to the other mode. In this embodiment, the multi-mode I/O device 123 can execute the touch-sensing operation if the multi-mode I/O device 123 is switched to the first mode. By contrast, the multi-mode I/O device 123 can perform the function of the electronic book if the multi-mode I/O device 123 is switched to the second mode. Thereby, the user can trigger the mode-switching signal at will, such that the multi-mode I/O device 123 can switch to a certain mode based on the user's demands.

It should be mentioned that the frame of the electronic book is displayed on the electronic paper 220 when the multi-mode I/O device 123 is in the second mode. Since the multi-mode I/O device 123 is disposed in the housing 121 of the electronic device 100 and is close to both hands of a user, as indicated in FIG. 1, other people are not allowed to take a furtive glance at the frame displayed on the electronic paper 220. However, according to another embodiment, the frame of the electronic paper can also be displayed on the main screen 110 by the driver of the electronic paper 220 for better display effects.

Based on the above, in the electronic device, the multi-mode I/O device, and the mode-switching method of the multi-mode I/O device, the electronic paper and the touch pad are stacked to form the multi-mode I/O device which can switch between the two modes. The multi-mode I/O device in the first mode executes the touch-sensing operation, while the multi-mode I/O device in the second mode displays the frame of the electronic book on the electronic paper and senses the touch action by using the touch pad. As such, the function of the electronic book can be accomplished with low costs and low power consumption. When the multi-mode I/O device is disposed in the electronic device, the normal touch operation can be executed by the multi-mode I/O device and, in the meantime, the electronic device can be equipped with the function of the electronic book. Thereby, the user of the electronic device is allowed to carry out diverse functions through the electronic device.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A multi-mode input/output device comprising:
a touch pad having a touch-sensing plane;
electronic paper having a first surface and a second surface opposite to the first surface, wherein an opening of an electronic device exposes the first surface of the electronic paper, and the second surface of the electronic paper contacts to the touch-sensing plane of the touch pad; and
a switching module connecting the touch pad and the electronic paper, the switching module switches the multi-mode input/output device between a first mode and a second mode when the switching module receives a mode-switching signal,
if the multi-mode input/output device is switched to the first mode, a display function of the electronic paper being disabled, the electronic device executing an operation based on a touch action sensed by the touch-sensing plane,
if the multi-mode input/output device is switched to the second mode, an electronic book menu being displayed on the electronic paper, a frame of the electronic book being displayed on the electronic paper based on the touch action sensed by the touch-sensing plane.

2. The multi-mode input/output device as claimed in claim 1, wherein the mode-switching signal is triggered by the touch action sensed by a specific region on the touch-sensing plane.

3. The multi-mode input/output device as claimed in claim 1, wherein the mode-switching signal is triggered when the touch action is constantly sensed by the touch-sensing plane for more than a predetermined period of time.

4. The multi-mode input/output device as claimed in claim 1, wherein the mode-switching signal is triggered by a physical key of the electronic device.

5. The multi-mode input/output device as claimed in claim 1, wherein when the electronic device executes the operation based on the touch action sensed by the touch-sensing plane, an operation frame corresponding to the operation is displayed on a main screen of the electronic device.

6. The multi-mode input/output device as claimed in claim 1, wherein the frame of the electronic book comprises at least one of the following: contents of the electronic book downloaded by the electronic device, an electronic book catalog, and a management interface of the electronic book.

7. The multi-mode input/output device as claimed in claim 1, further comprising:
an adhesive layer disposed between the touch-sensing plane and the second surface.

8. The multi-mode input/output device as claimed in claim 1, wherein the touch pad is a resistive touch pad.

9. An electronic device comprising:
a main screen; and
a host hinged to the main screen and comprising:
a housing having an opening; and
a multi-mode input/output device disposed in the housing and comprising:
a touch pad having a touch-sensing plane;
electronic paper having a first surface and a second surface opposite to the first surface, wherein the opening of the housing exposes the first surface of the electronic paper, and the second surface of the electronic paper contacts to the touch-sensing plane of the touch pad; and
a switching module connecting the touch pad and the electronic paper, the switching module switches the multi-mode input/output device between a first mode and a second mode when the switching module receives a mode-switching signal,
if the multi-mode input/output device is switched to the first mode, a display function of the electronic paper being disabled, the electronic device executing an operation based on a touch action sensed by the touch-sensing plane,
if the multi-mode input/output device is switched to the second mode, an electronic book menu being displayed on the electronic paper, a frame of the electronic book being displayed on the electronic paper based on the touch action sensed by the touch-sensing plane.

10. The electronic device as claimed in claim 9, wherein the mode-switching signal is triggered by the touch action sensed by a specific region on the touch-sensing plane.

11. The electronic device as claimed in claim 9, wherein the mode-switching signal is triggered when the touch action is constantly sensed by the touch-sensing plane for more than a predetermined period of time.

12. The electronic device as claimed in claim 9, wherein the mode-switching signal is triggered by a physical key of the electronic device.

13. The electronic device as claimed in claim 9, wherein when the electronic device executes the operation based on the touch action sensed by the touch-sensing plane, an operation frame corresponding to the operation is displayed on the main screen of the electronic device.

14. The electronic device as claimed in claim 9, wherein the frame of the electronic book comprises at least one of the following: contents of the electronic book downloaded by the electronic device, an electronic book catalog, and a management interface of the electronic book.

15. The electronic device as claimed in claim 9, wherein the multi-mode input/output device further comprises:
an adhesive layer disposed between the touch-sensing plane and the second surface.

16. The electronic device as claimed in claim 9, wherein the touch pad of the multi-mode input/output device is a resistive touch pad.

17. A mode-switching method comprising:
providing a multi-mode input/output device comprising a touch pad, electronic paper, and a switching module connecting the touch pad and the electronic paper, the touch pad having a touch-sensing plane, the electronic paper having a first surface and a second surface opposite to the first surface, an opening of an electronic device exposing the first surface of the electronic paper, the second surface of the electronic paper contacting to the touch-sensing plane of the touch pad; and
switching the multi-mode input/output device between a first mode and a second mode when the switching module receives a mode-switching signal, a display function of the electronic paper being disabled and the electronic device executing an operation based on a touch action sensed by the touch-sensing plane if the multi-mode input/output device is switched to the first mode, and an electronic book menu being displayed on the electronic paper and a frame of the electronic book being displayed on the electronic paper based on the touch action sensed by the touch-sensing plane if the multi-mode input/output device is switched to the second mode.

18. The mode-switching method as claimed in claim 17, further comprising one of the following steps:
triggering the mode-switching signal by the touch action sensed by a specific region on the touch-sensing plane;
triggering the mode-switching signal when the touch action is constantly sensed by the touch-sensing plane for more than a predetermined period of time; and
triggering the mode-switching signal by a physical key of the electronic device.

19. The mode-switching method as claimed in claim 17, wherein when the electronic device executes the operation based on the touch action sensed by the touch-sensing plane, an operation frame corresponding to the operation is displayed on a main screen of the electronic device.

20. The mode-switching method as claimed in claim 17, wherein the frame of the electronic book comprises at least one of the following: contents of the electronic book downloaded by the electronic device, an electronic book catalog, and a management interface of the electronic book.
